(19) United States
(12) Patent Application Publication
(10) Pub. No.: US 2010/0185324 A1
(43) Pub. Date: Jul. 22, 2010

(54) DEVICE FOR CONTROLLING A ROBOTIC ARM

(75) Inventor: Paolo Ferrara, Kematen an der Krems (AT)

Correspondence Address: MUIRHEAD AND SATURNELLI, LLC, 200 FRIBERG PARKWAY, SUITE 1001, WESTBOROUGH, MA, 01581, US

(73) Assignee: FERROBOTICS COMPLIANT TECHNOLOGY GMBH, Linz (AT)

(21) Appl. No.: 12/310,186

(22) PCT Filed: Sep. 18, 2007
(86) PCT No.: PCT/AT2007/000443

§ 371 Date: Feb. 13, 2009

(30) Foreign Application Priority Data
Sep. 18, 2006 (AT) A 1555/2006

(51) Int. Cl. B25J 9/16

(52) U.S. Cl. 700/245

(57) ABSTRACT

A device for controlling a robotic arm (1) is disclosed, comprising at least two branches (2, 3) connected to each other by an articulation and coupled to a support (4), each having an actuator (8) controlled by a controller, wherein either the branches (2, 3) are elastically flexible or the drive connection to the actuator (8) is elastically flexible. According to the invention, advantageous control conditions can be achieved by the controller for the actuators (8) of the branches (2, 3) each comprising a regulating stage (10) provided by a sensor (12, 22) with signals for the load either on the corresponding elastically flexible branch (2, 3) or the elastically flexible actuator (8), which may be controlled along the movement path thereof depending on the position of the bearing (5, 7) supporting the branch (2, 3).

### TECHNICAL AREA

The present invention relates to a device for controlling a robotic arm having at least two legs pivotably connected to each other and linked to a support, each of which has an actuator operatable via a control device, the legs either having a flexurally elastic design or being mechanically connected to an elastically flexible actuator.

### BACKGROUND INFORMATION

Industrial robot arms provided with arms to receive a tool or a workpiece or designed as a gripper in general have rigid legs, whose articulations absorb all forces and moments that occur. Contrary to rigid legs, legs having a flexurally elastic design deform under certain loads of the robotic arm. Due to the less strict requirements for mechanical strength, robotic arms having flexurally elastic arms which pivot with respect to each other may be constructed not only to be considerably lighter-weight but, due to their elastic response, may also be used for tasks which are complicated or impossible to perform using robotic arms having rigid legs and conventional actuators. In robotic arms having rigid legs, constructions having functions comparable to those of robotic arms having flexurally elastic legs are obtained only when the actuators have an elastically flexible design. Robotic arms having flexurally elastic legs or elastically flexible actuators, however, cause control problems, since the elastic deformations of the legs or the actuators are also to be taken into account. If the usual assumptions for the control of robotic arms having rigid legs are made, a higher degree of control complexity involving considerable computing work is unavoidable.

### SUMMARY OF THE INVENTION

The present invention is therefore based on the object of designing a device of the above-mentioned type for controlling a robotic arm in such a way that a guidance of the robotic arm that is sufficiently accurate for many applications may be ensured using a relatively low degree of complexity.

The present invention achieves this object in that the control device for the actuators of the legs each includes a regulator stage which may be affected by a transducer for applying the load either to the corresponding flexurally elastic leg or to the elastically flexible actuator, and which is activatable as a function of the position of the bearing which carries the leg along its path of motion.

The present invention is based on the recognition that the control complexity may be kept relatively low if each leg of the robotic arm may be regulated independently with respect to its flexurally elastic response or the response of its elastically flexible actuator. This initially assumes the knowledge of the flexurally elastic response of the individual legs or the individual actuators of the robotic arm. Due to the design specifications, the flexurally elastic response of the individual legs is determined, so that the elastic deformation of the particular leg for a predefined load may be ascertained. If the motion of a leg is referred to a reference system which is stationary with respect to the bearing for this leg, the pivoting motion of the leg in its bearing and the deformation of the leg which is a function of the leg load determine the position or the motion path of the leg end facing away from the bearing. Since the pivoting angle of the leg is predefined by the actuator acting upon this leg, and the elastic deformation of the leg is determined by its load, the position of the leg end facing away from the bearing in the reference system linked to the bearing may be ascertained with the aid of a transducer for the leg load and controlled using a regulator stage which is affected by the transducer for applying a load to the leg. The loads resulting in the deformation of the leg may be measured in a simple way via force sensors, e.g., in the form of strain gauges, independently from the particular type of load by gravitational forces, acceleration forces, inertial forces, or contact forces. This means that the actuators for the individual legs of the robotic arm may be activated, taking into account the loads acting on these legs and the associated elastic response of the legs, with the aid of the corresponding regulating stages in such a way that the leg end facing away from the bearing may be moved in the particular reference system while vibrations are largely suppressed, along a path which essentially follows a curve that is concentric with the bearing, but differs from it due to the bending of the legs. The elastic bending deformation of the individual legs due to the load, which results, on the one hand, in the leg end preceding or lagging behind the pivoting motion of the actuator, i.e., is taken into account by the regulating stages when activating the actuators, so that, for controlling the robotic arm, only the fact that, except for the leg linked to the support of the robotic arm, the bearings are moved along paths that are determined by the motion of the leg ends supporting the bearings is to be taken into account. Therefore, the paths of the ends of those legs which are mounted upstream from the leg to be controlled in a series of legs connected to the robotic arm support and to each other are also to be transmitted to the individual regulating stages. Since the actual values of the positions of the ends of the individual legs of the robotic arm are in general determined only mathematically as a function of the measured leg loads, accurate guidance of the robotic arm is impossible. The tolerance ranges that occur, however, are sufficient for many applications, in particular when a setpoint value of an end position is to be controlled.

The transducers for the load of the individual legs of the robotic arm may detect only the resulting total loads which are responsible for the deformation of the flexurally elastic leg, but not the components of the external forces acting upon the individual legs. Since the individual legs' own weights and flexurally elastic responses are known, not only the gravitational and acceleration forces, but also the retroactions of the other legs on the individual legs-due to these gravitational and acceleration forces may be computed taking into account the actuating paths and/or actuating speeds. The extra load occurring with respect to these computed loads must therefore be attributed to externally acting forces, which opens the advantageous possibility of regulating the robotic arm in such a way that it may be made to exert a predefined force such as required, for example, in grinding, or where a predefined maximum force is not to be exceeded, which is relevant, for example, in gripping movements.

For robotic arms having rigid legs but elastically flexible actuators for these legs basically similar relationships apply. Instead of the elastic deformations of the legs, only the elasticity of the actuators must be taken into account, which is achieved using a transducer for applying the load to the particular actuators, since the elastic response of the actuators is predefined by design and therefore known, so that the pivoting angles may be determined from the particular load on the actuators and the actuating path. The leg ends move along paths that are concentric with their bearings, which simplifies the computation of these paths compared to flexurally elastic legs.

To be able to take into account in a simple manner any movement of the bearings carrying the individual legs of the robotic arm for controlling the legs carried by these bearings, in robotic arms having flexurally elastic legs, a computing stage connected, on the one hand, to the transducer for the load of the leg carrying the bearing and, on the other hand, to an actual value transducer for the actuating path of the actuator for this leg, may be provided, so that the motion path of the bearings for the respective leg downstream from the series of legs connected to the support for the robotic arm may be ascertained via these computing stages preferably associated with the individual regulating stages and the regulating stage of this downstream leg may be predefined as the guidance path for its bearing. For robotic arms having elastically flexible actuators, the computing stage must be connected to the transducer for the load of the actuator of the leg carrying the bearing in order to ascertain the pivoting angle of the leg carrying the bearing from the actual value of the actuating path of the actuator which does not take into account the elastic component of the actuating path of the leg and the actuator load determining the elastic deformation.

### BRIEF DESCRIPTION OF THE DRAWINGS

The drawings show the subject matter of the present invention as an example.

FIG. 1 shows a device according to the present invention for controlling a robotic arm having flexurally elastic legs in a schematic block diagram, and

FIG. 2 shows a device according to the present invention for controlling a robotic arm having elastically flexible actuators in a schematic block diagram.

### DETAILS FOR IMPLEMENTING THE INVENTION

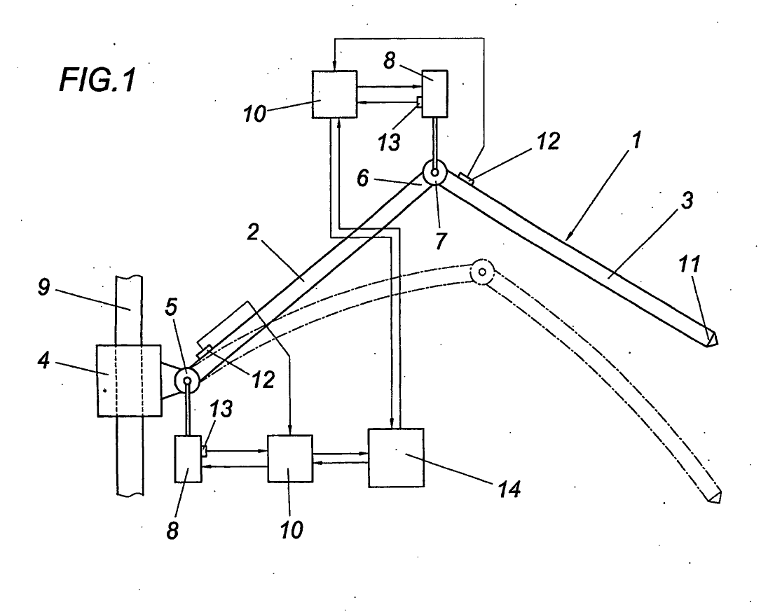

The exemplary embodiment illustrated in FIG. 1 has a robotic arm 1 having two flexurally elastic legs 2, 3. Robotic arm 1 is linked to a support 4 with the aid of its leg 2, specifically, with the aid of a bearing 5. The bearing for downstream leg 3, supported by leg 2 on its end 6 opposite to bearing 5, is labeled 7. The two legs 2 and 3 may be pivoted in their bearings 5 and 7 with the aid of an actuator 8 each. While actuator 8 for leg 2 is supported by support 4, leg 2 carrying bearing 7 forms a corresponding thrust bearing for actuator 8 of leg 3. To show that support 4 of robotic arm 1 does not need to be mounted in a stationary manner, the possible displacement of support 3 along a guide 9 is indicated in the present exemplary embodiment.

To control the individual legs 2, 3 of robotic arm 1, a regulating stage 10, which activates the corresponding actuator 8, is associated with each leg 2, 3. These regulating stages 10 are each provided with a computing stage, which, on the basis of appropriate program specifications, ascertains, from the load of the corresponding leg 2, 3 and the actuating path of actuator 8, the position or the path curve of end 6 or 11 of legs 2, 3 to be controlled, taking into account their particular flexurally elastic response, specifically with respect to a reference system which is linked to carrying bearings 5, 7 of the particular legs 2; 3. For leg 2 this means a reference system, fixedly linked to support 4, for moving end 6 of leg 2 and a reference system moving together with end 6 of this leg 2 for detecting the motion of end 11 of leg 3. Of course, the reference system in the area of bearing 5 may also be fixedly associated with leg 2, and the reference system in the area of bearing 7 may be fixedly associated with leg 3. The load on the particular legs 2, 3 is detected by transducers 12, for example, strain gauges, which are connected to regulating stages 10. The actuating path of actuators 8 is ascertained by actual value transducers 13, which also affect regulating stages 10.

With the help of regulating stage 10 for, actuator 8 of leg 2, the motion of bearing 7 for leg 3 supported by end 6 of leg 2 with respect to support 4 for robotic arm 1 may thus be controlled in a simple manner, specifically as a function of the particular load of leg 2. Similarly, the motion of end 11 of leg 3 with respect to end 6 of leg 2 is controlled via the corresponding regulating stage 10. In order to be able to draw a conclusion regarding the motion of end 11 of leg 3 with respect to support 4 of robotic arm 1, it must be taken into account according to the control technology that end 6 of leg 2 travels a certain path which, on the one hand, is determined by actuator 8 for leg 2 and, on the other hand, by the flexurally elastic response, dependent on the load, of this leg 2. The displacement of leg end 6 having bearing 7 for leg 3 is taken into account in the present exemplary embodiment by a central control device 14, which communicates the position or path curve of bearings 5, 7, which hold legs 2, 3, to the particular regulating stages 10, so that a simple control of robotic arm 1 results with the help of the individual regulating stages 10 associated with legs 2, 3.

In the drawing, robotic arm 1 in a starting position in which no elastic bending of legs 2, 3 occurs is illustrated using solid lines. Under a load of robotic arm 1 and appropriate activation of actuator 8, a position of robotic arm 1 as indicated by dash-dot lines may result. This yields that the displacement of bearing 7 is a function not only of the actuating path of the corresponding actuator 8, but also of the elastic deformation of leg 2. In order to ascertain and control the position of end 11 of leg 3, the elastic bending and the pivoting angle due to the actuating path of the corresponding drive 8 should also be determined for leg 3; the displacement of bearing 7 should also be taken into account via central control device 14. This central control device 14 is connected to individual regulating stages 10, on the one hand, in order to transmit the motion of legs 2, 3 of robotic arm 1 activated by regulating stage 10 to central control device 14, and, on the other hand, to supply the path data of the upstream legs to the individual regulating stages 10.

If a force is to be exerted via leg 3, this additional load of robotic arm 1 is also detected by transducers 12 of legs 2, 3. Since the static and dynamic forces which occur without additional external loads on robotic arm 1 may be computed, the additional load is obtained from the difference of the loads measured by transducers 12 and the computed loads, so that a relatively simple option is given for controlling robotic arm 1 also with respect to the way forces are applied and used.

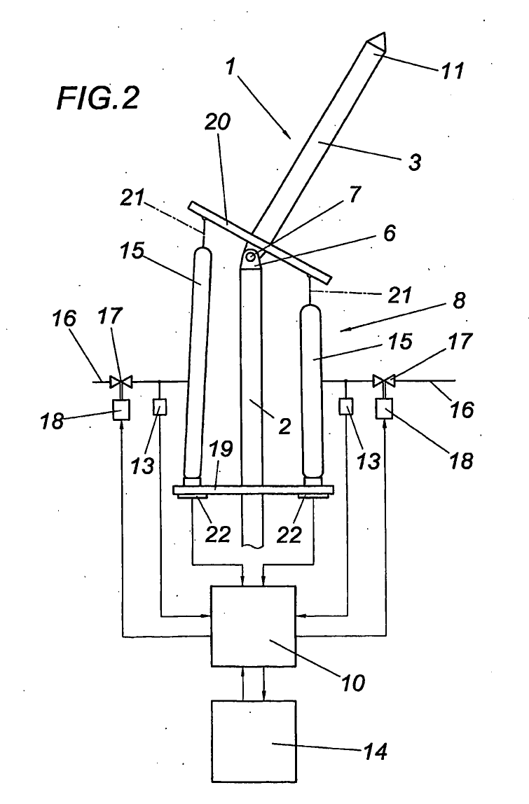

The exemplary embodiment according to FIG. 2 refers to a robotic arm 1, whose legs 2, 3 have a rigid design, but whose actuators 8 have elastic flexibility. These actuators 8, of which only the one for leg 3 is illustrated for the sake of clarity, are designed as so-called pneumatic muscles and include at least two elastically extensible hoses 15, to which pressurized air may be applied via supply lines 16, specifically via control valves 17, whose drives 18 are activated by the respective regulating stage 10. Since hoses 15, on the one hand, are supported by an elastic support 19 rigidly connected to leg 2 and, on the other hand, engage with an elastic support 20 of leg 3 via a traction means 21, in the event of unequal pressures applied to hoses 15, leg 3 pivots in support 7 under an unequal hose expansion. For a given pressure applied to hoses 15, leg 3 may pivot against an elastic restoring force due to the elastic response of hoses 15 when a corresponding force is applied, whether due to a gravitational load or due to acceleration forces or interference. These pivoting movements of leg 3 with respect to leg 2, independent of the pressure applied to hoses 15 via supply line 16, are detected by the transducers for the load of actuator 8 and supplied to regulating stage 10 to appropriately control the motion of leg 3. The load of actuators 8 may be measured with the aid of strain gauges which respond to the bending load on bending support 10. An actuator load may, however, also be detected via the traction load of traction means 21. The actual value of the actuating paths of hoses 15 may be determined via actual value transducer 13, which reproduces the pressure applied to hoses 15.

The path of leg end 6 required for determining the position of end 11 of leg 3 may be predefined, similarly to the specific embodiment of FIG. 1, by a control device 14. Of course, a robotic arm having elastically flexible actuators 8 according to FIG. 2 may also be controlled regarding forces to be applied or absorbed, since similar conditions as in robotic arms having flexurally elastic legs result regarding detection of the total load and computation of the load without external forces.

1. A device for controlling a robotic arm, comprising:
at least two legs articulatedly connected to each other and linked to a support, wherein each of the at least two legs is coupled to an actuator operatable via a control device, each of the legs being at least one of: flexurally elastic and mechanically connected to the actuator that acts as an elastically flexible actuator, wherein the control device for the actuator of each of the legs includes a regulating stage having a transducer for a load of at least one of: the corresponding flexurally elastic leg and the elastically flexible actuator, wherein the transducer is activatable as a function of a position of a bearing which carries at least one of the legs along a path of motion.

2. The device as recited in claim 1, wherein, for the robotic arm having flexurally elastic legs, a computing stage is provided which is connected to the transducer for the load of the at least one leg which carries the bearing and connected to an actual value transducer for the actuating path of the actuator for the at least one leg for activating the regulating stage as a function of the position of the bearing carrying the corresponding leg.

3. The device as recited in claim 1, wherein, for the robotic arm having elastically flexible actuators for the legs, for the load of the actuator of the at least one leg which carries the bearing and to an actual value transducer for the actuating path of the actuator for the at least one leg for activating the regulating stage as a function of the position of the bearing carrying the corresponding leg.

4. A device for controlling a robotic arm, comprising:
at least two flexurally elastic legs coupled via an articulated joint;
an actuator coupled to each of at least two flexurally elastic legs;
a control device that operates the actuator for each of the at least two flexurally elastic legs; and
a regulating stage coupled to the control device and which includes a transducer for each of the at least two flexurally elastic legs, wherein the transducer is activatable as a function of a position of each of the least two flexurally elastic legs along a path of motion.

5. The device as recited in claim 4, further comprising:
a computing stage coupled to the transducer for each of the at least two flexurally elastic legs that computes an actual value for the actuating path of the actuator for each of the at least two flexurally elastic legs that is used to activate the regulating stage as a function of the position of each of the least two flexurally elastic legs along the path of motion.

6. The device as recited in claim 4, wherein each of the at least two flexurally elastic legs includes a bearing that carries the corresponding leg along the path of motion.

7. The device as recited in claim 4, further comprising:
a support coupled to at least one of the flexurally elastic legs via another articulated joint.

8. A device for controlling a robotic arm, comprising:
at least two legs coupled via an articulated joint;
an elastically flexible actuator that is mechanically coupled in an elastically flexible manner to each of at least two legs;
a control device that operates the elastically flexible actuator for each of the at least two legs; and
a regulating stage coupled to the control device and which includes a transducer for each of the at least two legs, wherein the transducer is activatable as a function of a position of each of the least two legs along a path of motion.

9. The device as recited in claim 8, further comprising:
a computing stage coupled to the transducer for each of the at least legs that computes an actual value for the actuating path of the elastically flexible actuator for each of the at least two legs that is used to activate the regulating stage as a function of the position of each of the least two legs along the path of motion.

10. The device as recited in claim 8, wherein each of the at least two legs includes a bearing that carries the corresponding leg along the path of motion.

11. The device as recited in claim 8, further comprising:
a support coupled to at least one of the legs via another articulated joint.
